(19) United States
(12) Patent Application Publication
(10) Pub. No.: US 2018/0271272 A1
(43) Pub. Date: Sep. 27, 2018

(54) Insulated Cart

(71) Applicant: Judy Smith, Bronx, NY (US)

(72) Inventor: Judy Smith, Bronx, NY (US)

(21) Appl. No.: 15/466,965

(22) Filed: Mar. 23, 2017

(51) Int. Cl. A47B 31/02; B62B 3/00

(52) U.S. Cl. CPC A47B 31/02; A47B 2031/002; B62B 3/005

(57) ABSTRACT

An insulated cart for temperature controlled storage and transport includes a housing that defines an internal space. The housing is insulated. A plurality of trays is couplable to the housing and is selectively positionable in the internal space. The trays are positioned in the housing such that the internal space is configured to store items on the trays. An opening is positioned in a front of the housing and is configured to insert items through the opening to stow on the trays. A cover is hingedly coupled to the housing proximate to the opening. The opening is positioned in the housing such that the opening is configured to insert items, such as prepared foods, through the opening to stow on the trays. The cover is positioned to reversibly close the opening.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and

1.98.

The disclosure and prior art relates to carts and more particularly pertains to a new cart for temperature controlled storage and transport.

### BRIEF SUMMARY OF THE INVENTION

An embodiment of the disclosure meets the needs presented above by generally comprising a housing that defines an internal space. The housing is insulated. A plurality of trays is couplable to the housing and is selectively positionable in the internal space. The trays are positioned in the housing such that the internal space is configured to store items on the trays. An opening is positioned in a front of the housing and is configured to insert items through the opening to stow on the trays. A cover is hingedly coupled to the housing proximate to the opening. The opening is positioned in the housing such that the opening is configured to insert items, such as prepared foods, through the opening to stow on the trays. The cover is positioned to reversibly close the opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an insulated cart according to an embodiment of the disclosure.

FIG. 2 is an isometric perspective view of an embodiment of the disclosure.

FIG. 3 is a front view of an embodiment of the disclosure.

FIG. 4 is an isometric perspective view of an embodiment of the disclosure.

FIG. 5 is an exploded view of an embodiment of the disclosure.

### DETAILED DESCRIPTION OF THE INVENTION

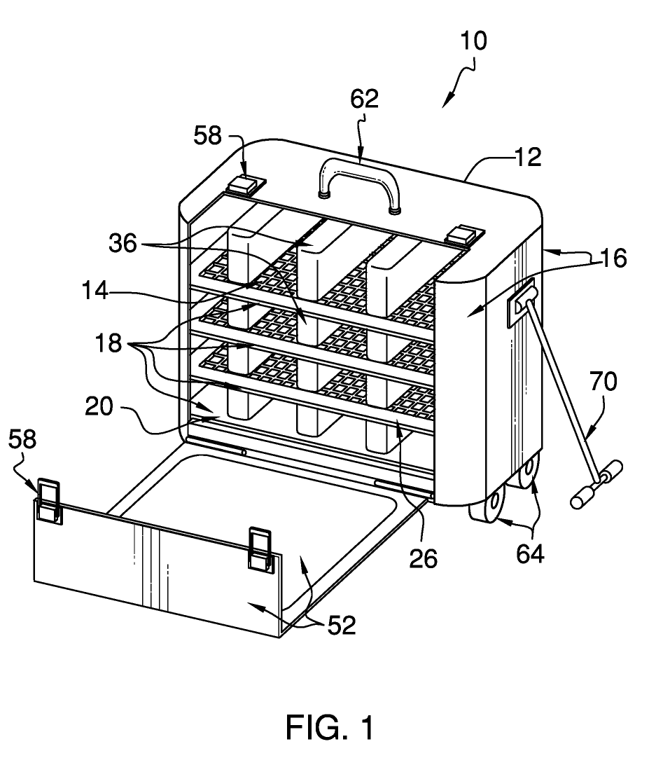

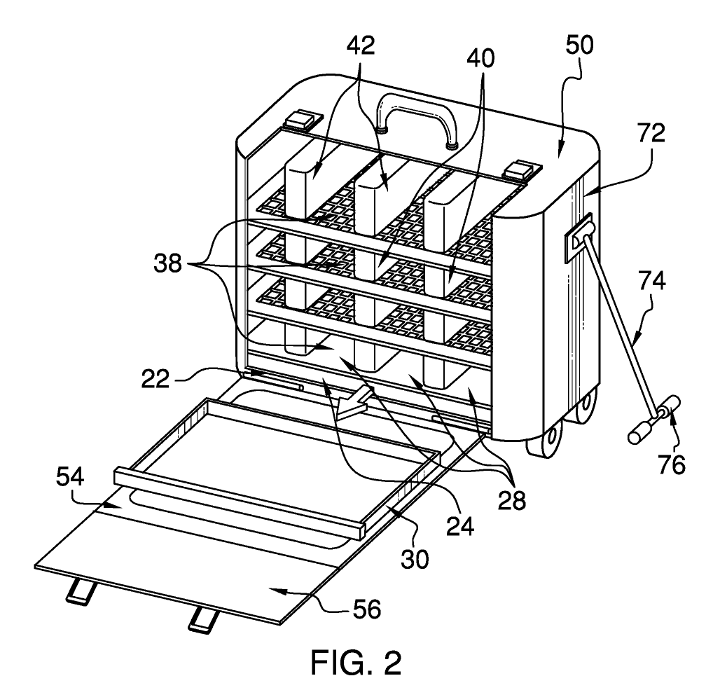

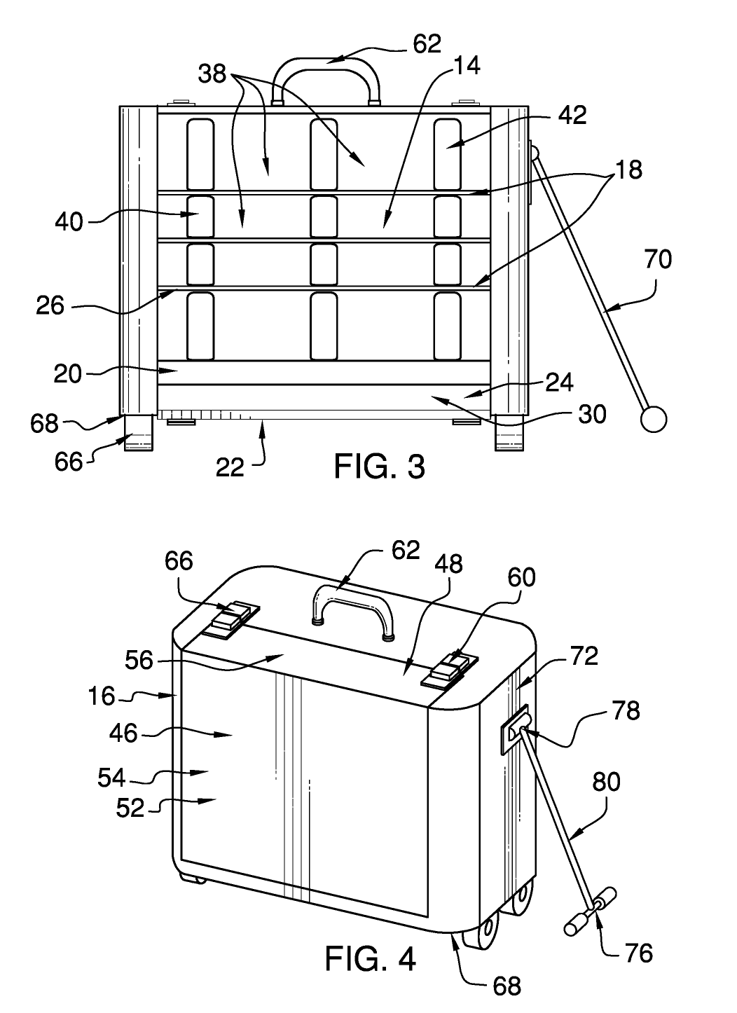

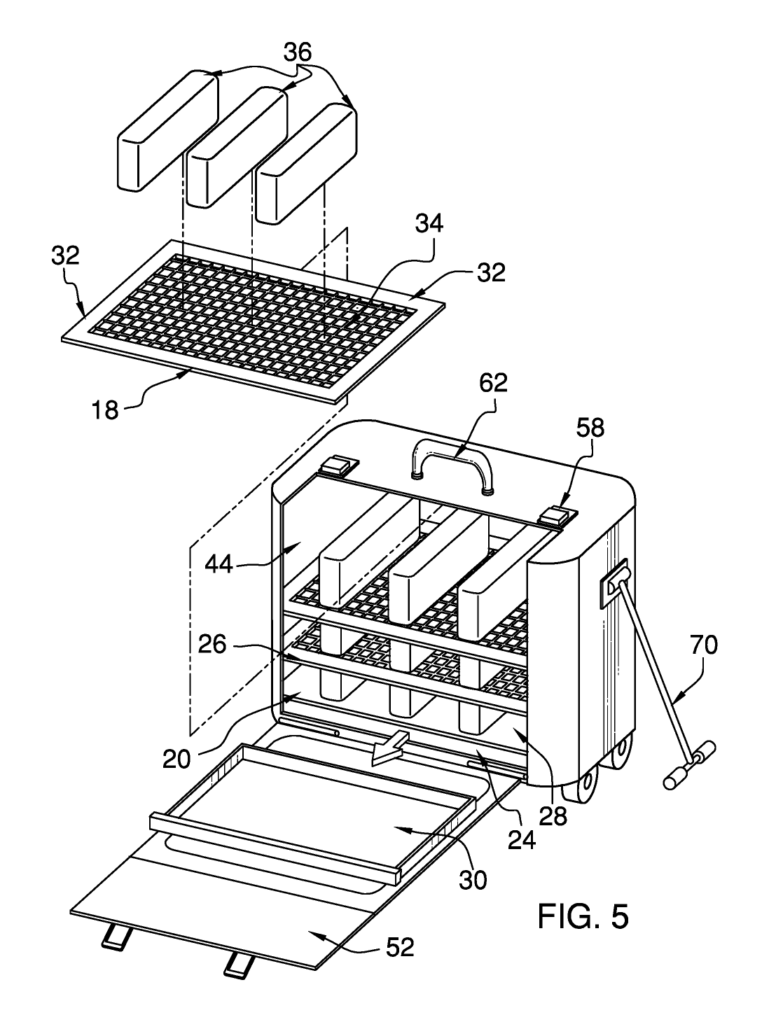

With reference now to the drawings, and in particular to FIGS. 1 through 5 thereof, a new cart embodying the principles and concepts of an embodiment of the disclosure and generally designated by the reference numeral 10 will be described.

As best illustrated in FIGS. 1 through 5, the insulated cart 10 generally comprises a housing 12 that defines an internal space 14. The housing 12 is insulated. The housing 12 is substantially rectangularly box shaped. The housing 12 has vertical edges 16, which in one embodiment are rounded.

A plurality of trays 18 is couplable to the housing 12 and is selectively positionable in the internal space 14. The trays 18 are positioned in the housing 12 such that the internal space 14 is configured to store items, such as prepared foods, on the trays 18. The plurality of trays 18 includes a lower tray 20 that is coupled to the housing 12 proximate to a bottom 22 of the housing 12, which defines a chamber 24. The chamber 24 is positioned in the housing 12 such that the chamber 24 is configured to insert a temperature maintaining item, such as ice.

The plurality of trays 18 includes a panel 26 that is insulated. The panel 26 is positionable adjacent to the lower tray 20 to define a lower storage zone 28. The lower storage zone 28 is positioned adjacent to the chamber 24 such that the lower storage zone 28 is configured for optimal temperature control.

The cart 10 also comprises a drawer 30 that is complementary to the chamber 24. The drawer 30 is reversibly positionable within the chamber 24 and is configured to stow a temperature maintaining item, such as ice.

Respective trays 18 comprise a perimeter support ring 32 and a mesh interior field 34 that is coupled to and extends from the perimeter support ring 32.

The cart 10 also comprises a plurality of inserts 36. The inserts 36 are selectively positionable between adjacent trays 18 to define a plurality of compartments 38. The adjacent trays 18 are positioned in substantial horizontal alignment within the internal space 14. In one embodiment, the plurality of inserts 36 comprises short spacers 40 and tall spacers 42. The short spacers 40 and the tall spacers 42 are selectively positionable between the adjacent trays 18 such that the trays 18 are variably vertically positionable within the internal space 14. The inserts 36 comprise expanded polystyrene foam.

An opening 44 is positioned in a front 46 of the housing 12. The opening 44 is positioned in the housing 12 such that the opening 44 is configured to insert items, such as prepared foods, through the opening 44 to stow on the trays 18. In one embodiment, the opening 44 is positioned in the front 46 and extends into a portion 48 of a top 50 of the housing 12.

A cover 52 is hingedly coupled to the housing 12 proximate to the opening 44. The cover 52 is positioned to reversibly close the opening 44. In one embodiment, the cover 52 comprises a lower section 54 and an upper section 56. The lower section 54 is hingedly coupled to the bottom 22 of the housing 12. The upper section 56 is hingedly coupled to the lower section 54 distal from the bottom 22. The upper section 56 is positioned on the lower section 54 such that the upper section 56 is positioned to reversibly close the portion 48 of the top 50 that comprises the opening 44.

A closure 58 is coupled to the housing 12 adjacent to the opening 44. The closure 58 is reversibly couplable to the cover 52. The closure 58 is positioned to couple to the cover 52 to close the opening 44. In one embodiment, the closure 58 comprises a pair of clasps 60.

A grasp 62 is coupled to the top 50 of the housing 12. The grasp 62 is positioned on the housing 12 such that one or more fingers of a hand of a user are insertable between the grasp 62 and the top 50 of the housing 12 to lift the housing 12.

A plurality of rollers 64 is rotationally coupled to the bottom 22 of the housing 12. The rollers 64 are positioned on the bottom 22 such that the housing 12 is configured to roll on a substantially vertical surface. In one embodiment, the plurality of rollers 64 comprises wheels 66 that are coupled singly to the bottom 22 proximate to each lower corner 68 of the housing 12.

A handle 70 is pivotally coupled to a side 72 of the housing 12 proximate to the top 50. The handle 70 is positioned on the housing 12 such that the handle 70 is configured to grasp in the hand of the user to roll the housing 12 on the rollers 64. In one embodiment, the handle 70 comprises a rod 74 and a bar 76. The rod 74 is coupled at a first end 78 to the side 72 of the housing 12. The bar 76 is coupled to the rod 74 distal from the housing 12. The bar 76 is positioned on the rod 74 such that the bar 76 is configured to grasp in the hand of the user. In one embodiment, the rod 74 comprises a plurality of nested sections 80 such that the rod 74 is extendable.

In use, the opening 44 is positioned in the housing 12 and is configured to insert items, such as prepared foods, through the opening 44 to stow on the trays 18. The drawer 30 is reversibly positionable within the chamber 24. The drawer 30 is configured to stow a temperature maintaining item such as ice. The lower storage zone 28 is positioned adjacent to the chamber 24 such that the lower storage zone 28 configured for optimal temperature control. The cover 52 is positioned to reversibly close the opening 44. The handle 70 is positioned on the housing 12 and is configured to grasp in the hand of the user to roll the housing 12 on the rollers 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An insulated cart comprising:
a housing defining an internal space, said housing being insulated;
a plurality of trays couplable to said housing and selectively positionable in said internal space, wherein said trays are positioned in said housing such that said internal space is configured for storage of items, such as prepared foods, on said trays;
an opening positioned in a front of said housing, wherein said opening is positioned in said housing such that said opening is configured for insertion of items, such as prepared foods, through said opening for stowage on said trays;
a cover hingedly coupled to said housing proximate to said opening, wherein said cover is positioned to reversibly close said opening; and
wherein said opening is positioned in said housing such that said opening is configured for insertion of items, such as prepared foods, through said opening for stowage on said trays, wherein said cover is positioned to reversibly close said opening.

2. The cart of claim 1, further including said housing being substantially rectangularly box shaped.

3. The cart of claim 2, further including said housing having vertical edges, said vertical edges being rounded.

4. The cart of claim 1, further including said plurality of trays including a lower tray coupled to said housing proximate to a bottom of said housing defining a chamber, wherein said chamber is positioned in said housing such that said chamber is configured for insertion of a temperature maintaining item such as ice.

5. The cart of claim 4, further including a drawer complementary to said chamber, said drawer being reversibly positionable within said chamber, such that said drawer is configured for stowage of a temperature maintaining item such as ice.

6. The cart of claim 4, further including said plurality of trays including a panel, said panel being insulated, said panel being positionable adjacent to said lower tray defining a lower storage zone, wherein said lower storage zone is positioned adjacent to said chamber such that said lower storage zone configured for optimal temperature control.

7. The cart of claim 1, further including respective said trays comprising a perimeter support ring and a mesh interior field coupled to and extending from said perimeter support ring.

8. The cart of claim 1, further including a plurality of insert, said inserts being selectively positionable between adjacent said trays defining a plurality of compartments, wherein said adjacent said trays are positioned in substantial horizontal alignment within said internal space.

9. The cart of claim 8, further including said plurality of inserts comprising short spacers and tall spacers, wherein said short spacers and said tall spacers are selectively positionable between said adjacent said trays such that said trays are variably vertically positionable within said internal space.

10. The cart of claim 8, further including said inserts comprising expanded polystyrene foam.

11. The cart of claim 1, further comprising:
said opening being positioned in said front and extending into a portion of a top of said housing;
said cover comprising a lower section and an upper section, said lower section being hingedly coupled to a bottom of said housing, said upper section being hingedly coupled to said lower section distal from said bottom; and
wherein said upper section is positioned on said lower section such that said upper section is positioned to reversibly close said portion of said top comprising said opening.

12. The cart of claim 1, further including a closure coupled to said housing adjacent to said opening, said closure being reversibly couplable to said cover, wherein said closure is positioned to couple to said cover to close said opening.

13. The cart of claim 12, further including said closure comprising a pair of clasps.

14. The cart of claim 1, further including a grasp coupled to a top of said housing, wherein said grasp is positioned on said housing such that one or more fingers of a hand of a user are insertable between said grasp and said top of said housing for lifting said housing.

15. The cart of claim 1, further including a plurality of rollers rotationally coupled to a bottom of said housing, wherein said rollers are positioned on said bottom such that said housing is configured for rolling on a substantially vertical surface.

16. The cart of claim 15, further including said plurality of rollers comprising wheels coupled singly to said bottom proximate to each lower corner of said housing.

17. The cart of claim 15, further including a handle pivotally coupled to a side of said housing proximate to said top, wherein said handle is positioned on said housing such that said handle is configured for grasping in the hand of the user to roll said housing on said rollers.

18. The cart of claim 17, further including said handle comprising a rod and a bar, said rod being coupled by a first end to said side of said housing, said bar being coupled to said rod distal from said housing, wherein said bar is positioned on said rod such that said bar is configured for grasping in the hand of the user.

19. The cart of claim 18, further including said rod comprising a plurality of nested sections such that said rod is extendable.

20. An insulated cart comprising:
a housing defining an internal space, said housing being insulated, said housing being substantially rectangularly box shaped, said housing having vertical edges, said vertical edges being rounded;
a plurality of trays couplable to said housing and selectively positionable in said internal space, wherein said trays are positioned in said housing such that said internal space is configured for storage of items, such as prepared foods, on said trays, said plurality of trays including a lower tray coupled to said housing proximate to a bottom of said housing defining a chamber, wherein said chamber is positioned in said housing such that said chamber is configured for insertion of a temperature maintaining item such as ice, said plurality of trays including a panel, said panel being insulated, said panel being positionable adjacent to said lower tray defining a lower storage zone, wherein said lower storage zone is positioned adjacent to said chamber such that said lower storage zone configured for optimal temperature control, respective said trays comprising a perimeter support ring and a mesh interior field coupled to and extending from said perimeter support ring;
a drawer complementary to said chamber, said drawer being reversibly positionable within said chamber, such that said drawer is configured for stowage of a temperature maintaining item such as ice;
a plurality of insert, said inserts being selectively positionable between adjacent said trays defining a plurality of compartments, wherein said adjacent said trays are positioned in substantial horizontal alignment within said internal space, said plurality of inserts comprising short spacers and tall spacers, wherein said short spacers and said tall spacers are selectively positionable between said adjacent said trays such that said trays are variably vertically positionable within said internal space, said inserts comprising expanded polystyrene foam;
an opening positioned in a front of said housing, wherein said opening is positioned in said housing such that said opening is configured for insertion of items, such as prepared foods, through said opening for stowage on said trays, said opening being positioned in said front and extending into a portion of a top of said housing;
a cover hingedly coupled to said housing proximate to said opening, wherein said cover is positioned to reversibly close said opening, said cover comprising a lower section and an upper section, said lower section being hingedly coupled to said bottom of said housing, said upper section being hingedly coupled to said lower section distal from said bottom, wherein said upper section is positioned on said lower section such that said upper section is positioned to reversibly close said portion of said top comprising said opening;
a closure coupled to said housing adjacent to said opening, said closure being reversibly couplable to said cover, wherein said closure is positioned to couple to said cover to close said opening, said closure comprising a pair of clasps;
a grasp coupled to said top of said housing, wherein said grasp is positioned on said housing such that one or more fingers of a hand of a user are insertable between said grasp and said top of said housing for lifting said housing;
a plurality of rollers rotationally coupled to said bottom of said housing, wherein said rollers are positioned on said bottom such that said housing is configured for rolling on a substantially vertical surface, said plurality of rollers comprising wheels coupled singly to said bottom proximate to each lower corner of said housing;
a handle pivotally coupled to a side of said housing proximate to said top, wherein said handle is positioned on said housing such that said handle is configured for grasping in the hand of the user to roll said housing on said rollers, said handle comprising a rod and a bar, said rod being coupled by a first end to said side of said housing, said bar being coupled to said rod distal from said housing, wherein said bar is positioned on said rod such that said bar is configured for grasping in the hand of the user, said rod comprising a plurality of nested sections such that said rod is extendable; and
wherein said opening is positioned in said housing such that said opening is configured for insertion of items, such as prepared foods, through said opening for stowage on said trays, wherein said drawer is reversibly positionable within said chamber, such that said drawer is configured for stowage of a temperature maintaining item such as ice, wherein said lower storage zone is positioned adjacent to said chamber such that said lower storage zone configured for optimal temperature control, wherein said cover is positioned to reversibly close said opening.
